(19) United States
(12) Patent Application Publication
(10) Pub. No.: US 2014/0211978 A1
(43) Pub. Date: Jul. 31, 2014

(54) System and Method to Detect Video Piracy

(71) Applicant: HCL Technologies Limited, Chennai (IN)

(72) Inventors: Kumaralingam Ramamoorthy, Chennai (IN); Vengadassalabady Ramanouudjam, Chennai (IN); Rahul Ganapathy Subramaniam, Chennai (IN); Joy Esther Samuel, Chennai (IN)

(21) Appl. No.: 13/910,012

(22) Filed: Jun. 4, 2013

(30) Foreign Application Priority Data
Jan. 30, 2013 (IN) 419/CHE/2013

(51) Int. Cl. G06T 1/00

(52) U.S. Cl. CPC G06T 1/0085
USPC 382/100

(57) ABSTRACT

System and Method to detect video piracy. This embodiment relates to management of video files, and more particularly to detecting piracy in video files. The embodiments herein achieve a system and method to detect video piracy by using unique identifiers embedded in escape frames in a video.

### PRIORITY DETAILS

The present application claims priority from Indian Application Number 419/CHE/2013, filed on 30 Jan. 2013, the disclosure of which is hereby incorporated by reference herein.

### TECHNICAL FIELD

This embodiment relates to management of videos, and more particularly to detecting piracy in videos.

### BACKGROUND

Currently, with the widespread use of internet, the ability for a user to access video has increased. The user may use online streaming web sites such as YouTube to view videos. The user may also download videos and view them offline. The user may also access the video using a physical medium such as a Digital Video Disk, Compact Disc and so on.

With this easy access of videos, illegal access and viewing of videos (referred to as piracy) has also increased. At present, there are more pirated videos accessible via the internet than legal copies of the video. This results in a huge loss of revenue for the stakeholders (such as producers, production houses, studios and so on).

To detect pirated video, a number of methods such as video signatures, logos superimposed on the video, digital watermarks, barcodes, readable text and so on are being implemented. However, these techniques result in a reduction in the viewing experience of the user, as the above mentioned technologies are visible to the user and may distract the user, during his viewing experience.

Further, with a wide variety of video viewing devices available (such as Televisions, computers, laptops, mobile phones, tablets and so on), the resolution of the video is not steady across all devices. The above mentioned technologies become unreliable, and hence video piracy is unable to be detected.

There are also technologies where a digital signature (may be in the form of text) are inserted into the headers of video files. However, these are not easily detectable when the video is being viewed.

### OBJECT

The principal object of this embodiment is to achieve a system and method to detect video piracy by using unique identifiers embedded in escape frames in a video.

### STATEMENT OF EMBODIMENT

Disclosed herein is a method for detecting video piracy, the method comprising of including at least one escape frame at intervals in a video by a transcoder, wherein the at least one escape frame comprises of a unique video identifier; checking for the escape frame by a viewing device, when viewing the video; extracting the unique video identifier from the escape frame by the viewing device, on the viewing device detecting the escape frame; and using the unique video identifier to locate a source of the video.

Disclosed herein is a method for encoding a video, the method comprising of including at least one escape frame at intervals in a video by a transcoder, wherein the at least one escape frame comprises of a unique video identifier.

Disclosed herein is a method for detecting video piracy, the method comprising of checking for an escape frame by a viewing device, when viewing the video; extracting a unique video identifier from the escape frame by the viewing device, on the viewing device detecting the escape frame; and using the unique video identifier to locate a source of the video.

Disclosed herein is a system for detecting video piracy, the system configured for including at least one escape frame at intervals in a video by a transcoder, wherein the at least one escape frame comprises of a unique video identifier; checking for the escape frame by a viewing device, when viewing the video; and extracting the unique video identifier by the viewing device, on the viewing device detecting the escape frame; and using the unique video identifier to locate a source of the video.

Disclosed herein is a device for encoding a video, the device configured for including at least one escape frame at intervals in a video, wherein the at least one escape frame comprises of a unique video identifier.

Disclosed herein is a device for detecting video piracy, the device configured for checking for an escape frame, when viewing the video; extracting a unique video identifier from the escape frame, on the device detecting the escape frame; and using the unique video identifier to locate a source of the video.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 is a flowchart depicting the process of transcoding and detecting video piracy, according to embodiments as disclosed herein;

FIG. 2 depicts a transcoding system, according to embodiments as disclosed herein;

FIG. 3 depicts a transcoder, according to embodiments as disclosed herein;

FIGS. 4a and 4b are flowcharts illustrating the steps involved in the process of transcoding a video, according to embodiments as disclosed herein;

FIG. 5 depicts a video viewing system, according to embodiments as disclosed herein;

FIG. 6 depicts a viewing device, according to embodiments as disclosed herein; and

FIG. 7 is a flowchart depicting the steps involved in the process of detecting video piracy, according to embodiments as disclosed

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

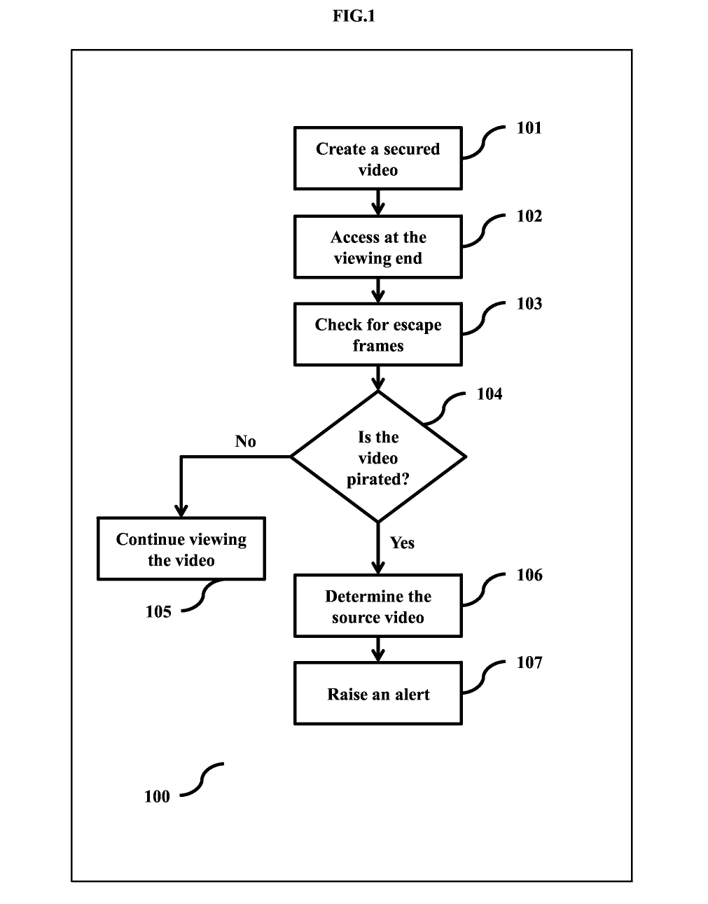

The embodiments herein achieve a system and method to detect video piracy by using unique identifiers embedded in escape frames in a video. Referring now to the drawings, and more particularly to FIGS. 1 through 6, where similar reference characters denote corresponding features consistently throughout the figures, there are shown preferred embodiments.

FIG. 1 is a flowchart depicting the process of transcoding video and detecting video piracy, according to embodiments as disclosed herein. A video is received and a secured video is created (101) from the received video. The secured video may be created by inserting an escape frame, which is displayed for a very brief duration, such that the escape frame is not visible to the human eye when the video is viewed at a normal viewing rate. In other words, the frame rate is less than the frame rate visible to the normal human eye. On the video being received (102) at the viewing end, a check is made (103) for the escape frame. On detecting the escape frame, a check is made (104) if the video has been pirated. If the video has not been pirated, the video may be continued to be viewed (105). If the video has been pirated, the source video is determined (106) and an appropriate alert is raised (107). The various actions in method 100 may be performed in the order presented, in a different order or simultaneously. Further, in some embodiments, some actions listed in FIG. 1 may be omitted.

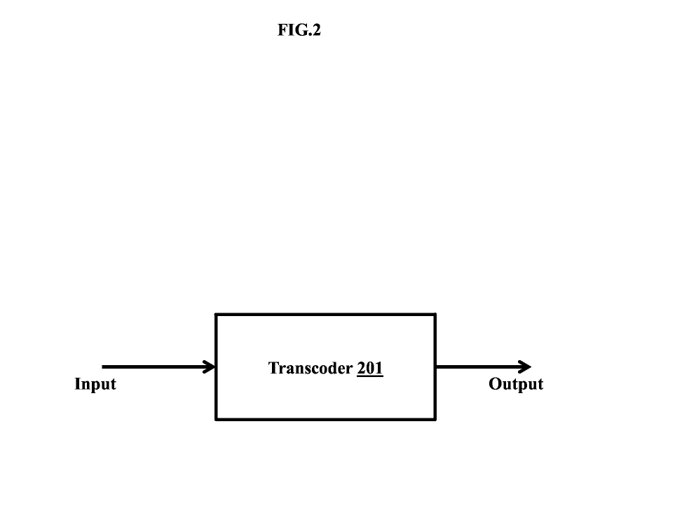

FIG. 2 depicts a transcoding system, according to embodiments as disclosed herein. The transcoding system comprises of a transcoder 201. The transcoder 201 is configured to receive a video as an input. The video may be received directly from a video capturing apparatus (such as a video camera, a digital camera, a mobile phone and so on). The transcoder 201 may fetch the video from a storage location such as a database or a server.

On receiving the video, the transcoder 201 splits the video into a plurality of frames. The number of frames may depend on a plurality of factors such as video formats, resolution of the video, Frames per second (fps) of the video and so on. The number of frames may also be defined by an authorized person. The transcoder 201 includes the escape frame at pre-defined intervals. The pre-defined intervals may be defined by an authorized person. In another embodiment herein, the transcoder 201 may include the escape frame at the end of every frame. The transcoder 201 may also include the escape frame after a pre-specified number of frames, where the number of frames may be specified by an authorized person. The escape frame comprises a hidden object, hereinafter referred to as a unique video identifier. The unique video identifier is unique to each video. For example, consider a movie is being input to the transcoder 201. Each version of the movie being released for viewing via the transducer 101 includes a unique video identifier. The unique video identifier may comprise of text, an image, a short video or a combination of one or more of the same. The transcoder 201 may include the unique video identifier in the escape frame as scalable barcode impression. The unique video identifier may be generated based on a plurality of factors comprising of video formats, resolution of the video, Frames per second (fps) of the video, a reduction in the fps (if any), quality improvement in the video (if required) and so on. The duration of the escape frame is such that it is not visible to a person viewing the video at the normal viewing rate. In an embodiment herein, the duration of the escape frame may be 1/500 seconds or less. The transcoder 201 may further mention to display the escape frame for the time duration of the escape frame before the next frame.

Presentation Time Stamp (PTS)=(i/fps−1/x)

Where (i≧0 to n), n is the total number of frames and 1/x is the duration of the escape frame.

The transcoder 201 further re-assembles the video and prepares the video for output. The transcoder 201 may output the video into a database for storage, where at least one other user may access the video.

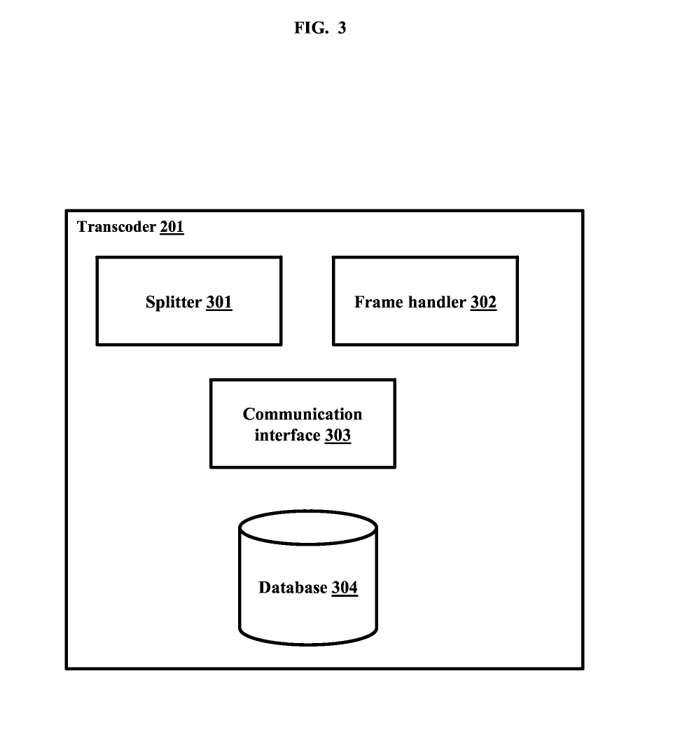

FIG. 3 depicts a transcoder, according to embodiments as disclosed herein. The transcoder 201, as depicted, comprises of a splitter 301, a frame handler 302, a communication interface 303 and at least one database 304. The splitter 301 receives the video via the communication interface 303. The communication interface 303 may receive the video from the video capturing apparatus. The communication interface 303 may fetch the video from a storage location such as a database or a server.

On receiving the video, the splitter 301 splits the video into a plurality of frames. The splitter 301 may split the video into the number of frames depending on a plurality of factors such as video formats, resolution of the video, Frames per second (fps) of the video and so on. The number of frames may also be defined by an authorized person. The frame handler 302 includes the escape frame at pre-defined intervals. The pre-defined intervals may be defined by an authorized person. In another embodiment herein, the frame handler 302 may include the escape frame at the end of every frame. The frame handler 302 may also include the escape frame after a pre-specified number of frames, where the number of frames may be specified by an authorized person. The frame handler 302 further generates the unique video identifier for insertion into the escape frame. The unique video identifier is unique to each video. The frame handler 302 may generate the unique video identifier comprising of text, an image, a short video or a combination of one or more of the same. The frame handler 302 may include the unique video identifier in the escape frame as scalable barcode impression. The frame handler 302 is configured to modulate the duration of the escape frame, such that the escape frame is not visible to a person viewing the video at the normal viewing rate. In an embodiment herein, the duration of the escape frame may be 1/500 seconds or less. The frame handler 302 may further mention to display the escape frame for a time duration of the escape frame before the next frame.

Presentation Time Stamp (PTS)=(i/fps−1/x)

Where (i≧0 to n), n is the total number of frames and 1/x is the duration of the escape frame.

The frame handler 302 further re-assembles the video and prepares the video for output, via the communication interface 303. The communication interface 303 may output the video into a database for storage, where at least one other user may access the video.

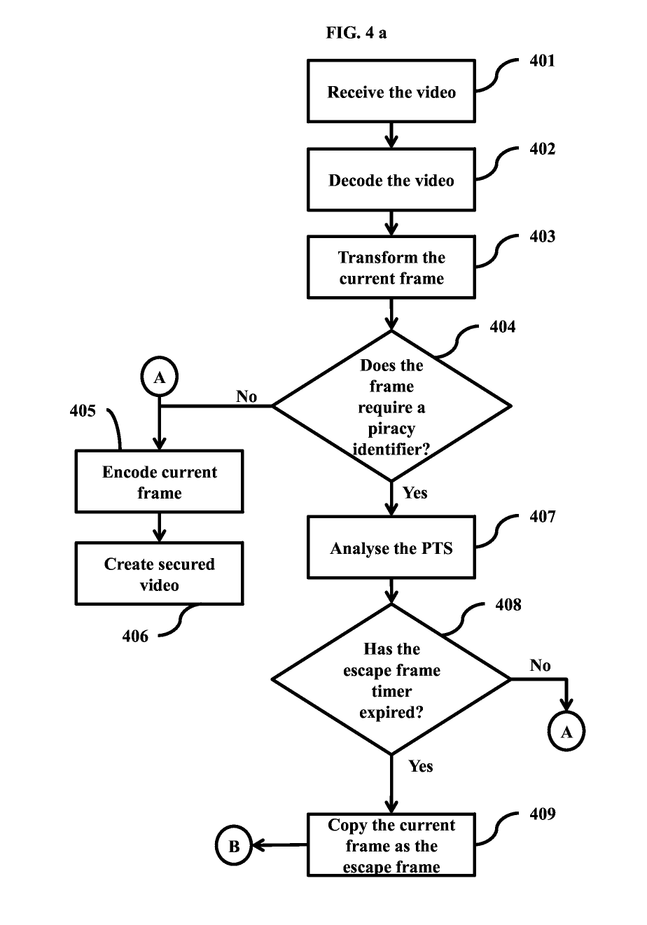

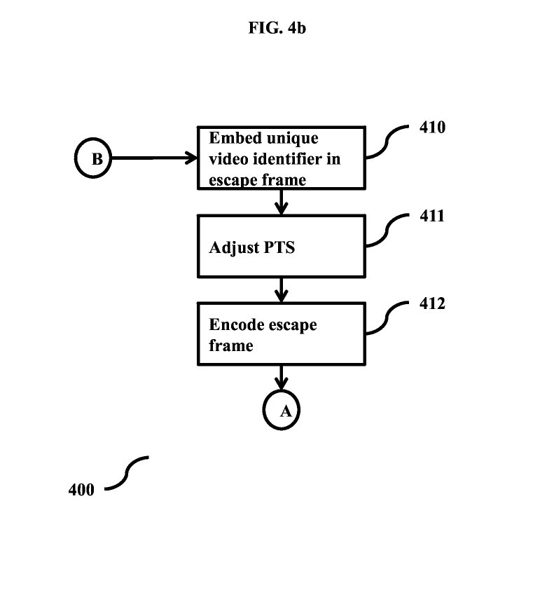

FIGS. 4a and 4b are flowcharts illustrating the steps involved in the process of transcoding a video, according to embodiments as disclosed herein. The transcoder 201 receives (401) the video. The transcoder 201 may receive the video from the video capturing apparatus. The transcoder 201 may fetch the video from a storage location such as a database or a server. On receiving the video, the transcoder 201 decodes (402) the video by splitting the video into a plurality of frames and transforms (403) the current frame, wherein the current frame is the frame being decoded by the transcoder 201 at present. The transcoder 201 checks (404) if the current frame requires a piracy identifier. If the current frame does not require a piracy identifier, the transcoder 201 encodes (405) the current frame. If the current frame requires a piracy identifier, the transcoder 201 analyses (407) the PTS and checks (408) if the escape frame timer has expired. If the escape frame timer has not expired, the transcoder 201 encodes (405) the current frame. If the escape frame timer has expired, the transcoder 201 copies (409) the current frame as the escape frame and embeds (410) a unique video identifier in the escape frame. The transcoder 201 further adjusts (411) the PTS and encodes (412) the escape frame. The transcoder 201 then encodes (405) the current frame and creates (406) the secured video. The various actions in method 400 may be performed in the order presented, in a different order or simultaneously. Further, in some embodiments, some actions listed in FIG. 4 may be omitted.

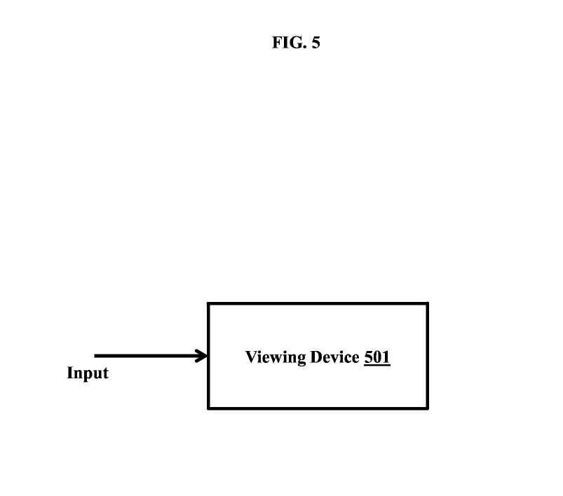

FIG. 5 depicts a video viewing system, according to embodiments as disclosed herein. The viewing system comprises of a viewing device 501, connected to a video source. The viewing device 501 may be any device, which can enable a user to view a video, such as a television, a computer, a laptop, a mobile phone, a tablet and so on. The video source may be an online server, connected to the viewing device 501 using suitable means. The video source may also be a physical source, such as a Compact Disc (CD), a Digital Video Disk (DVD), a Blu-ray disk, a cassette, a memory storage means (such as a flash drive, a USB drive, a memory stick and so on) or any other physical source capable of storing video and capable of being accessed by the viewing device 501.

The viewing device 501 decodes the video as the user is accessing the video. The viewing device 5011 checks if the PTS of each received frame is below a specified value. The specified value is the length of the escape frame as encoded into the video (1/x or less). On the viewing device 501 detecting that the PTS of the frame is below the range, the viewing device 501 determines that the current frame is an escape frame.

The viewing device 501 decodes the escape frame to extract the unique video identifier. The viewing device 501 then compares the unique video identifier to a set of stored unique identifiers to identify the source of the video. On detecting the source of the video, the viewing device 501 may take appropriate actions, such as raising an alert, halting the viewing of the video and so on.

In an embodiment herein, the viewing device 501 may extract the video information from the unique video identifier and further use the extracted information to locate the source video.

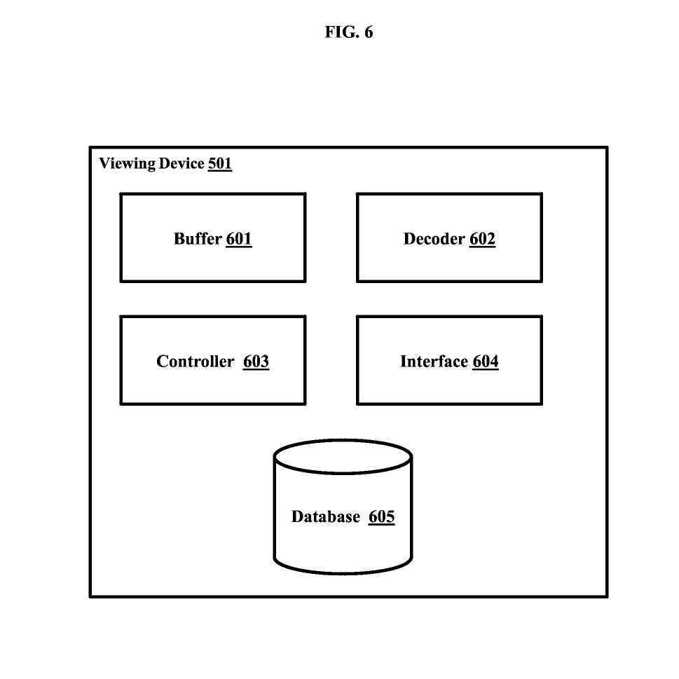

FIG. 6 depicts a viewing device, according to embodiments as disclosed herein. The viewing device 501, as depicted, comprises of a buffer 601, a decoder 602, a controller 603, an interface 604 and a database 605. The interface 604 is an interface between the viewing device 501 and the source of the video and enables the viewing device 501 to fetch the video. The buffer 601 is used to buffer the video, as the user is watching the video.

The decoder 602 decodes the video as the user is accessing the video. The decoder 602 may decode the video as it is directly received from the interface. The decoder 602 may also decode the portions of the video present in the buffer 601. On the decoder 602 decoding the video, the controller 603 checks if the PTS for each frame is below a specified value. The specified value is the length of the escape frame as encoded into the video (1/x or less). On the controller 603 detecting that the PTS of the frame is below the range, the controller 603 determines that the current frame is an escape frame.

The controller 603 decodes the escape frame to extract the unique video identifier. The controller 603 then compares the unique video identifier to a set of stored unique identifiers to identify the source of the video. The set of unique stored identifiers may be present in the database 605 present internally. The set of unique stored identifiers may be present in a database present external to the viewing device 501 and connected to the viewing device 501 using a suitable means. On detecting the source of the video, the controller 603 may take appropriate actions, such as raising an alert, halting the viewing of the video and so on.

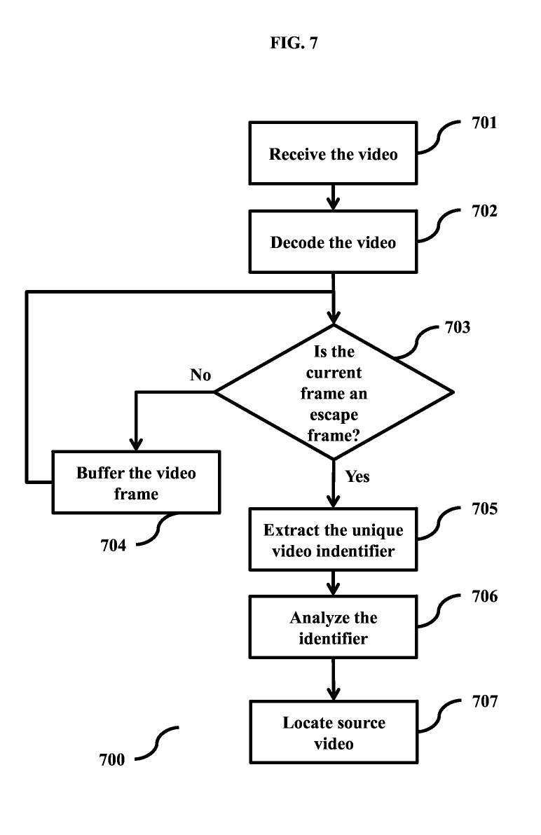

FIG. 7 is a flowchart depicting the steps involved in the process of detecting video piracy, according to embodiments as disclosed herein. The viewing device 501 receives (701) the video and decodes (702) the video as the user is accessing the video. The viewing device 501 may decode the video as it is directly received from the interface. The viewing device 501 may also decode the portions of the video present in the buffer 601. The viewing device 501 checks (703) if the current frame is an escape frame. The viewing device 501 checks if the PTS for each frame is below a specified value. The specified value is the length of the escape frame as encoded into the video (1/x or less). On the viewing device 501 detecting that the PTS of the frame is below the range, the viewing device 501 determines that the current frame is an escape frame. If the current frame is not an escape frame, the viewing device 501 buffers (704) the video frame. The viewing device 501 extracts (705) the unique video identifier by decoding the escape frame. The viewing device 501 then analyses (706) the identifier by comparing the unique video identifier to a set of stored unique identifiers to identify the source of the video. Using the identifier, the viewing device 501 locates (707) the source of the video. The various actions in method 700 may be performed in the order presented, in a different order or simultaneously. Further, in some embodiments, some actions listed in FIG. 7 may be omitted.

The embodiments disclosed herein can be implemented through at least one software program running on at least one hardware device and performing network management functions to control the network elements. The network elements shown in FIGS. 2, 3, 5 and 6 include blocks which can be at least one of a hardware device, or a combination of hardware device and software module.

The embodiments herein achieve a system and method to detect video piracy by using unique identifiers embedded in escape frames in a video. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program several software modules being executed on at least one hardware device. The hardware device can be any kind of portable device that can be programmed. The method embodiments described herein could be implemented partly in hardware and partly in software. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for detecting video piracy, the method comprising of
including at least one escape frame at intervals in a video by a transcoder, wherein the at least one escape frame comprises of a unique video identifier;
checking for the escape frame by a viewing device, when viewing the video;
extracting the unique video identifier from the escape frame by the viewing device, on the viewing device detecting the escape frame; and
using the unique video identifier to locate a source of the video.

2. The method, as claimed in claim 1, wherein the intervals is at least one of
pre-defined by an authorized person;
an end of each frame in the video; and
after a specified number of frames in the video.

3. The method, as claimed in claim 1, wherein the unique video identifier is unique to each video.

4. The method, as claimed in claim 1, wherein duration of the escape frame is less than frame rate visible to a normal human eye.

5. The method, as claimed in claim 1, wherein checking for the escape frame further comprises of
checking if PTS (Presentation Time Stamp) of the current frame is below a specified range; and
considering the current frame as an escape frame, if PTS of the current frame is below the specified range.

6. The method, as claimed in claim 1, wherein checking for the source of the video comprises of
comparing the unique video identifier to a set of stored video identifiers.

7. A method for encoding a video, the method comprising of including at least one escape frame at intervals in a video by a transcoder, wherein the at least one escape frame comprises of a unique video identifier.

8. The method, as claimed in claim 7, wherein the intervals is at least one of
pre-defined by an authorized person;
an end of each frame in the video; and
after a specified number of frames in the video.

9. The method, as claimed in claim 7, wherein the unique video identifier is unique to each video.

10. The method, as claimed in claim 7, wherein duration of the escape frame is less than the frame rate visible to the normal human eye.

11. A method for detecting video piracy, the method comprising of
checking for an escape frame by a viewing device, when viewing the video;
extracting a unique video identifier from the escape frame by the viewing device, on the viewing device detecting the escape frame; and
using the unique video identifier to locate a source of the video.

12. The method, as claimed in claim 11, wherein the unique video identifier is unique to each video.

13. The method, as claimed in claim 11, wherein duration of the escape frame is less than frame rate visible to a normal human eye.

14. The method, as claimed in claim 11, wherein checking for the escape frame further comprises of
checking if PTS (Presentation Time Stamp) of the current frame is below a specified range; and
considering the current frame as an escape frame, if PTS of the current frame is below the specified range.

15. The method, as claimed in claim 11, wherein checking for the source of the video comprises of
comparing the unique video identifier to a set of stored video identifiers.

16. A system for detecting video piracy, the system configured for
including at least one escape frame at intervals in a video by a transcoder, wherein the at least one escape frame comprises of a unique video identifier;
checking for the escape frame by a viewing device, when viewing the video; and
extracting the unique video identifier by the viewing device, on the viewing device detecting the escape frame; and
using the unique video identifier to locate a source of the video.

17. The system, as claimed in claim 16, wherein the system is configured for considering the intervals as at least one of
pre-defined by an authorized person;
an end of each frame in the video; and
after a specified number of frames in the video.

18. The system, as claimed in claim 16, wherein the system is configured for creating the unique video identifier, such that the unique video identifier is unique to each video.

19. The system, as claimed in claim 16, wherein the system is configured for keeping duration of the escape frame less than frame rate visible to a normal human eye.

20. The system, as claimed in claim 16, wherein the system is configured for checking for the escape frame by
checking if PTS (Presentation Time Stamp) of the current frame is below a specified range; and
considering the current frame as an escape frame, if PTS of the current frame is below the specified range.

21. The system, as claimed in claim 16, wherein the system is configured for checking for the source of the video by
comparing the unique video identifier to a set of stored video identifiers.

22. A device for encoding a video, the device configured for including at least one escape frame at intervals in a video, wherein the at least one escape frame comprises of a unique video identifier.

23. The device, as claimed in claim 22, wherein the device is configured for considering the intervals as at least one of
pre-defined by an authorized person;
an end of each frame in the video; and
after a specified number of frames in the video.

24. The device, as claimed in claim 22, wherein the device is configured for creating the unique video identifier, such that the unique video identifier is unique to each video.

25. The device, as claimed in claim 22, wherein the device is configured for keeping duration of the escape frame less than the frame rate visible to the normal human eye.

26. A device for detecting video piracy, the device configured for
checking for an escape frame, when viewing the video;
extracting a unique video identifier from the escape frame, on the device detecting the escape frame; and
using the unique video identifier to locate a source of the video.

27. The device, as claimed in claim 26, wherein the device is configured for checking for the escape frame by
checking if PTS (Presentation Time Stamp) of the current frame is below a specified range; and
considering the current frame as an escape frame, if PTS of the current frame is below the specified range.

28. The device, as claimed in claim 26, wherein the device is configured for checking for the source of the video by
comparing the unique video identifier to a set of stored video identifiers.
